(19) United States
(12) Patent Application Publication
(10) Pub. No.: US 2013/0099065 A1
(43) Pub. Date: Apr. 25, 2013

(54) TILT-WING AIRCRAFT

(71) Applicant: EADS Deutschland GmbH, Ottobrunn (DE)

(72) Inventor: Johannes Stuhlberger, Tegernsee (DE)

(73) Assignee: EADS DEUTSCHLAND GMBH, Ottobrunn (DE)

(21) Appl. No.: 13/675,646

(22) Filed: Nov. 13, 2012

Related U.S. Application Data
(63) Continuation of application No. PCT/EP2011/058141, filed on May 19, 2011.

(30) Foreign Application Priority Data
May 19, 2010 (DE) 10 2010 021 022.6

(51) Int. Cl. B64C 27/22

(52) U.S. Cl. CPC B64C 27/22; Y10S 903/902
USPC 244/7 C; 903/902

(57) ABSTRACT

A tilt-wing aircraft is provided. The tilt-wing aircraft includes a tail drive and control unit. The control unit is configured to generate a forward thrust. The control unit can also generate an upwardly or downwardly directed thrust component and/or a laterally directed thrust component in hover flight and in climb flight of the aircraft.

### CROSS-REFERENCE TO RELATED APPLICATIONS

This is a continuation of International Application No. PCT/EP2011/058141, filed May 19, 2011, which claims priority to German Application No. 10 2010 021 022.6, filed May 19, 2010, which are each hereby incorporated by reference in their entirety.

### TECHNICAL FIELD

The present disclosure relates to a tilt-wing aircraft and to a method for the operation thereof.

### BACKGROUND

Tilt-wing aircraft have been known in principle for a long time. The article by William F. Chana and T. M. Sullivan: “The Tilt Wing Design for a Family of High Speed VSTOL Aircraft”, presented at the American Helicopter Society, 49th Annual Forum, St. Louis, Mo., 19-21 May 1993 provides a good overview.

Accordingly, it may be desirable to provide an improved tilt-wing aircraft. In addition, other objects, desirable features and characteristics will become apparent from the subsequent summary and detailed description, and the appended claims, taken in conjunction with the accompanying drawings and this background.

### SUMMARY

According to the various teachings of the present disclosure, provided is an improved tilt-wing aircraft.

One of various aspects of the present disclosure relates to a tilt-wing aircraft with a tail drive and control unit which is configured to generate a forward thrust and to also generate an upwardly or downwardly directed thrust component and/or a laterally directed thrust component during hover flight of the aircraft.

A tail drive unit of this type can provide a particular proportion or even most of the forward thrust of the aircraft during cruise flight. The result of this is that noise emissions generated, for example, by front propellers attached to the tilt wing are displaced from the aircraft cabin to the tail.

Furthermore, due to the forward thrust generated by the tail drive unit, the propellers of the aircraft attached to the tilt wing can be optimised in respect of hover flight and climb flight, whereas the tail drive unit is optimised in respect of cruise flight.

According to another of various aspects of the present disclosure, the tail drive and control unit comprises a tail propeller creating an air flow against an empennage of the aircraft. The empennage can be of a conventional configuration, with an elevator and a rudder, or can be configured, for example, as a V empennage.

According to another of various aspects of the present disclosure, the tail drive and control unit has a sheathed tail propeller. In this case, it can be configured as a sheathed tail propeller which can be pivoted about the vertical axis and the transverse axis of the aircraft to provide the necessary thrust components.

The drive of the tilt-wing aircraft can be of a conventional configuration, with turbines and a gear unit.

According to another of various aspects of the present disclosure, the tilt-wing aircraft according to the present disclosure comprises a hybrid drive which has for each propeller of the aircraft a respective electric motor driving the propeller, and which has at least one energy generating module which is provided with an internal combustion engine and a generator to generate electrical energy.

Since each propeller is driven by an electric motor, it is unnecessary to connect the two propellers provided for hover flight and climb flight to a transmission shaft, as is required in the case of a tiltrotor aircraft, for example of the type Bell-Boeing V22 Osprey, to counteract the failure of an engine. In the present disclosure, each electric motor is generally configured to be redundant.

The power required for the drive can be provided via a motor or turbine unit which is common to all propellers, and the power can then be distributed in an optimised manner onto the propellers by an electric coupling, according to the mission task. To achieve a redundancy of the hybrid drive, another of various aspects of the present disclosure provides at least one further energy generating module.

The electric motors used in the present disclosure are generally configured as a low-inertia direct drive of a high power intensity, as described in DE 10 2007 013 732 A1, i.e. as electric machines with permanent excitation which are generally suitable for a direct drive of the propellers due to a high specific torque and power intensity and to a low moment of inertia.

According to another of various aspects of the present disclosure, a storage unit for electrical energy is provided. This unit can be used to power the electric motors driving the propellers, at least temporarily, additionally or alternatively. This also increases the redundancy.

According to another of various aspects of the present disclosure, the one energy generating module and the further energy generating module are configured to be the same or similar. This measure makes it possible to achieve a modular construction, comprising a plurality of energy generating modules which are each provided with an internal combustion engine and a generator.

However, according to another of various aspects of the present disclosure, the further energy generating module can be configured as a fuel cell unit. This fuel cell unit can provide current for charging the storage unit for electrical energy, or can provide additional current for the operation of the electric motors.

According to another of various aspects of the present disclosure, the electrical energy generated by the at least one energy generating module is distributed onto the electric motors driving the propellers, subject to operating requirements. In this respect, for example the electric motor which drives the tail rotor is supplied with more electrical energy during cruise flight than it requires during hover flight or climb flight.

Therefore, according to another of various aspects of the present disclosure, during cruise flight most of the electrical energy is supplied to the electric motor which drives the tail propeller.

In an extreme case, the entire forward thrust could also be provided by the tail propeller, in which case the front propellers attached to the tilt wing can be optimised in respect of low resistance during normal operation or can even be stopped aerodynamically.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a perspective view of a tilt-wing passenger aircraft according to the various teachings of the present disclosure;

FIG. 2 shows an unmanned tilt-wing aircraft according to the present disclosure;

FIGS. 3A-3E show an unmanned tilt-wing aircraft according to the present disclosure, in which FIG. 3A is a side view of the aircraft in climb flight, FIG. 3B is a front view of the aircraft in hover flight, FIG. 3C is a plan view of the aircraft in climb flight, FIG. 3D is a corresponding perspective view of the aircraft and FIG. 3E is a perspective view of the aircraft in cruise flight;

FIGS. 4A-4D show an unmanned tilt-wing aircraft according to the present disclosure in cruise flight, FIG. 4A is a side view of the aircraft, FIG. 4B is a front view of the aircraft, FIG. 4C is a plan view of the aircraft and FIG. 4D is a perspective view of the aircraft;

FIGS. 5A-5C show the flight control of a tilt-wing aircraft according to the present disclosure, FIG. 5A showing the pitch control, FIG. 5B showing the roll control and FIG. 5C showing the yaw control;

FIG. 6 schematically shows a hybrid drive for a tilt-wing aircraft according to the present disclosure; and

FIG. 7 schematically shows a further hybrid drive for a tilt-wing aircraft according to the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

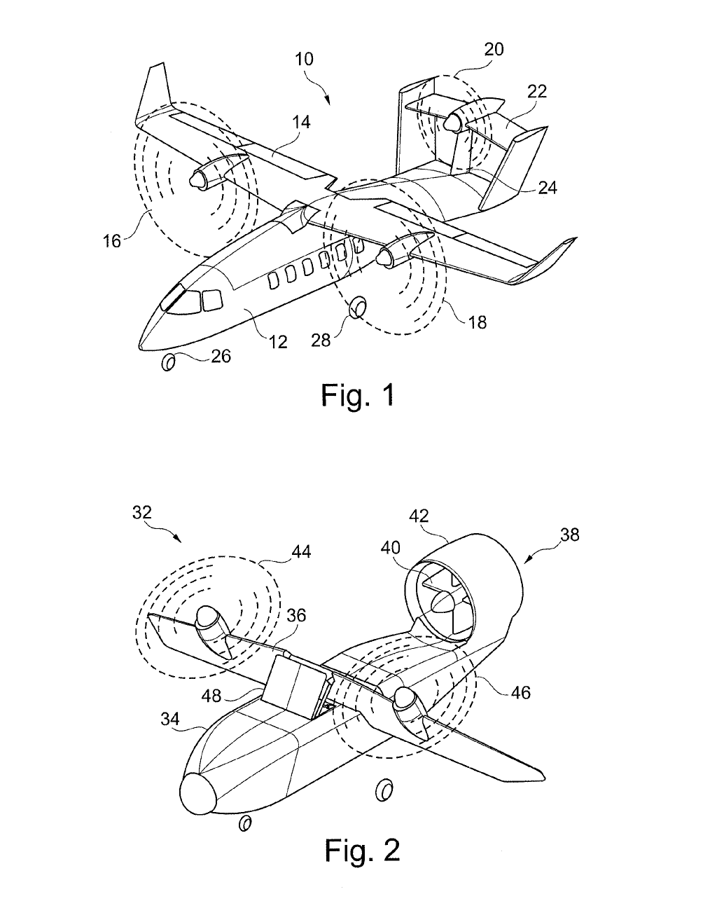

FIG. 1 shows a tilt-wing aircraft 10 according to the present disclosure configured as a passenger aircraft. The aircraft comprises a fuselage 12, a tilt wing 14 to which are attached a front propeller 16 on the right-hand side and a front propeller 18 on the left-hand side, and also comprises a tail propeller 20 which creates air flow against an empennage which comprises a horizontal tail plane 22 and a rudder unit 26. FIG. 1 also schematically shows a nose wheel 26 and a left side wheel 28 of the aircraft.

FIG. 2 shows an unmanned aircraft, a so-called UAV (unmanned aerial vehicle) which is configured as a tilt-wing aircraft 32 according to the present disclosure. UAVs of this type are also known as drones. Here, unlike, model aircraft for example, a UAV is understood as meaning an aircraft which has sufficient load bearing capacity and adequate flight characteristics for information and mission assignments, for example for the transportation and cameras for information purposes, or for the transportation of weapons for mission purposes. The drone 32 has a fuselage 34, a tilt wing 36 and a sheathed tail propeller 38 comprising the actual tail propeller 40 and a sheath 42. Front propellers 44 and 46 are attached to the tilt wing 36.

FIG. 1 shows the tilt wing 14 of the aircraft 10 in a cruise position, while FIG. 2 shows the tilt wing 36 of the drone 32 in the position for climb flight. For hover flight, the tilt wing is pivoted to such an extent that the leading and trailing edges thereof (in the cruise flight position) are approximately located on the vertical axis of the aircraft.

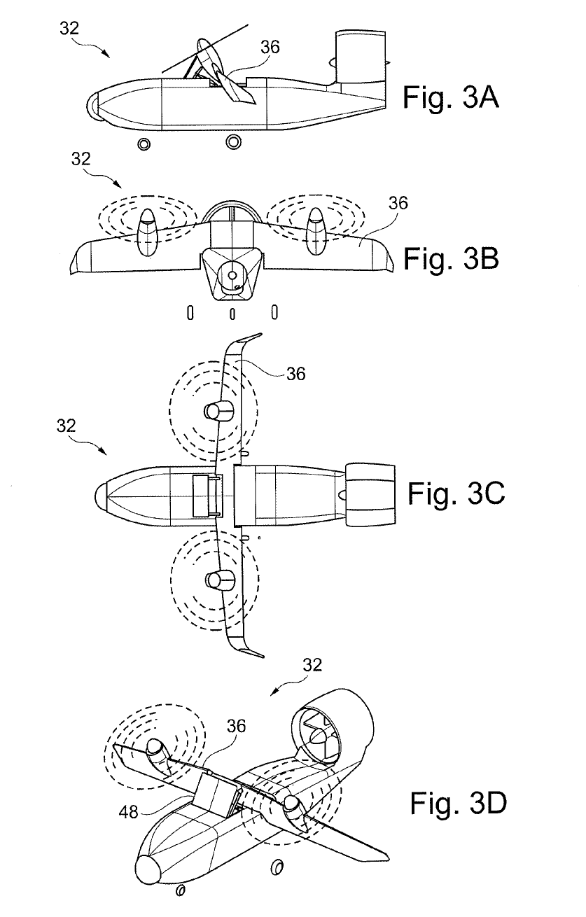

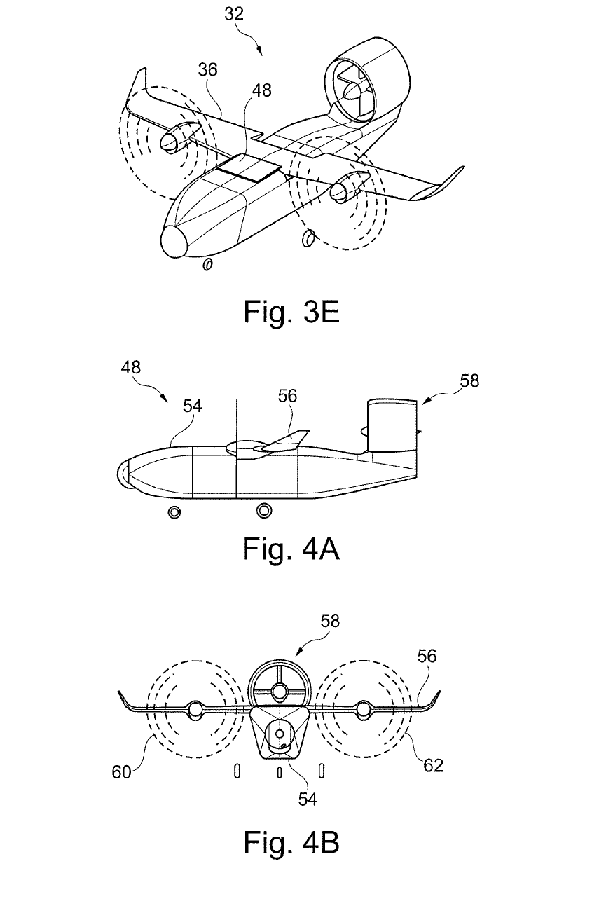

FIGS. 3A-3E illustrate the different flight states of a drone 32 which comprises a tilt wing 36 and a flap 48 which is closed in cruise flight but is open during hover flight or climb flight to allow the tilt wing 36 to tilt.

FIG. 3A is a side view of the drone 32 in climb flight; FIG. 3B is a front view of the drone 32 in hover flight; FIG. 3C is a plan view of the drone 32 in climb flight; FIG. 3D is a perspective view of the drone 32 in climb flight (with open flap 48); and FIG. 3E is a perspective view of the drone 32 in cruise flight (with closed flap 48).

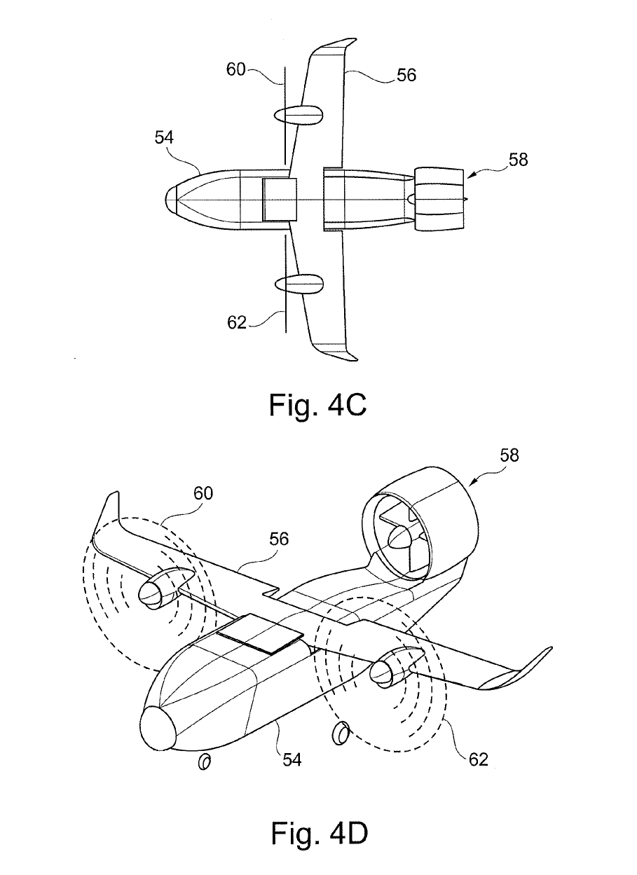

FIGS. 4A-4D illustrate the different flight states of a drone 48 which comprises a fuselage 54, a tilt wing 56 and a sheathed tail propeller 58. FIG. 4A is a side view of the drone 48 in cruise flight; FIG. 4B is a front view of the drone which has a front propeller 60 and a front propeller 62 on the tilt wing 56; FIG. 4C is a plan view of this drone; and FIG. 4D is a perspective view of this drone in cruise flight.

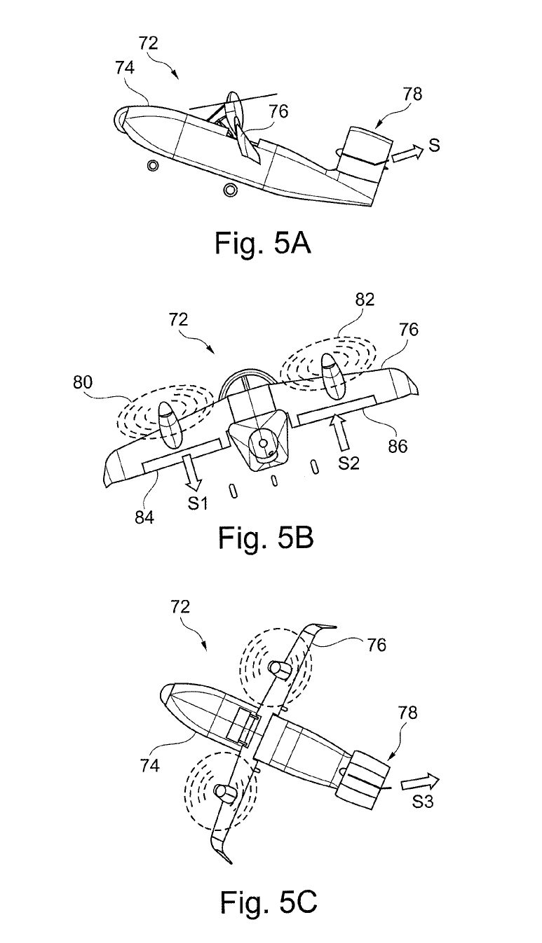

FIGS. 5A-5C illustrate the flight control of a tilt-wing aircraft 72 according to the present disclosure, said tilt-wing aircraft 72 comprising a fuselage 74, a tilt wing 76, a sheathed tail propeller 78 and two front propellers 80, 82 on the tilt wing 76. As can be seen from the front view of FIG. 5B, the tilt wing 76 is also provided with a left-hand aileron 84 and a right-hand aileron 86.

As shown in FIG. 5A, the pitch control of the tilt-wing aircraft 72 is achieved by the production of an upwardly directed thrust vector component S by the sheathed tail propeller 78.

As shown in FIG. 5B, the roll control of the tilt-wing aircraft 72 (about the longitudinal axis of the aircraft) is achieved by the production of thrust vectors produced by the ailerons 84, 86 and/or by the production of a different thrust due to the front propellers 80, 82, as shown by the thrust vectors or thrust vector components S1 (directed downwards) and S2 (directed upwards).

As shown in FIG. 5C, the yaw control of the tilt-wing aircraft 72 according to the present disclosure is achieved by the provision of a laterally (sideways) directed thrust vector component S3 by the sheathed tail propeller 78.

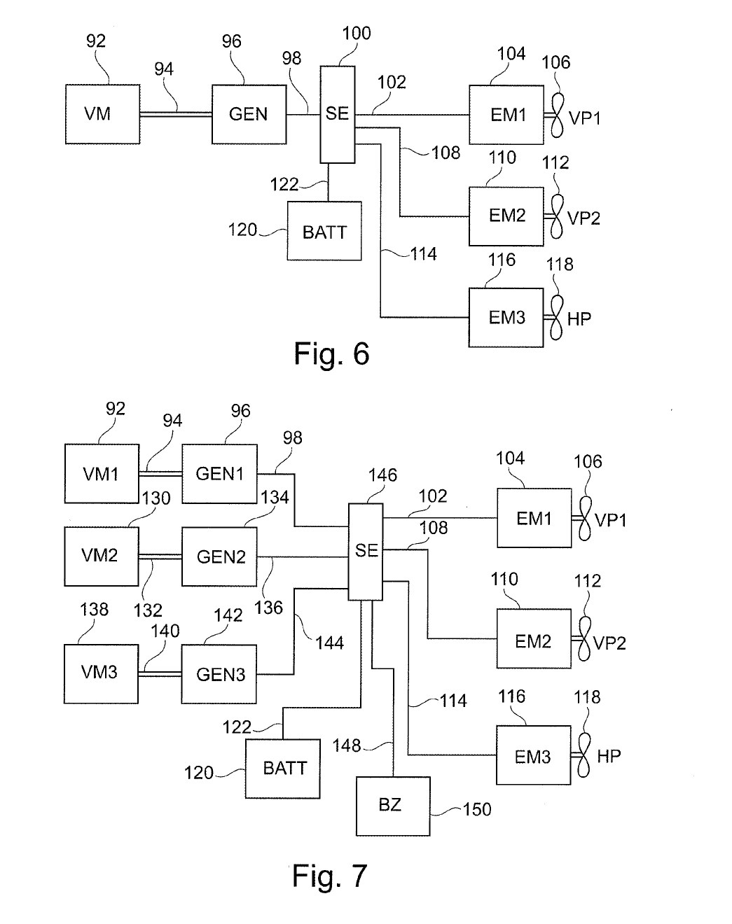

FIG. 6 schematically shows a hybrid drive for a tilt-wing aircraft according to the present disclosure. Via a shaft 94, an internal combustion engine 92 drives a generator 96 which sends electric current 98 via a line 98 to a central control unit 100. The central control unit 100 distributes the generated electrical energy as required or depending on the operating state via a first line 102 to an electric motor 104 which drives a first front propeller 106, and/or via a line 108 to a second electric motor 110 which drives a second front propeller 112, and/or via a line 114 to a third electric motor 116 which drives a tail propeller 118. Furthermore, the control unit 100 can supply current to a battery 120 via a line 122, but can also take current from said battery 120 to support the operation of at least one of the electric motors 104, 110, 116 (so-called “boost”).

Internal combustion engine 92 and generator 96 form an energy generating module. The internal combustion engine can be, for example a Wankel engine, a piston engine or a turbine.

As electric engines, the electric motors 104, 110, 116 can be configured considerably smaller and lighter than mechanical turbo or motor drive units.

The electrical energy generated by the energy generating module 92, 96, being optimised in respect of the respective operating state, is distributed onto the electric motors 104, 110, 116. The electric motors have the further advantage that their speed can be varied much faster than is the case for an internal combustion engine as a driving motor.

A further advantage is seen in the fact that since electric motors are of a considerably smaller and lighter construction as electric engines, as described above, tilting mechanisms for the tilt wing as well as engines generating lift and forward thrust can be configured in a substantially simplified manner.

FIG. 7 shows an exemplary embodiment of the hybrid drive according to the present disclosure in which, compared to FIG. 6, two additional energy generating modules 130, 134 and 138, 142 are provided, as well as corresponding lines 136, 144. As in FIG. 6, the first energy generating module comprises an internal combustion engine 92 which drives a generator 96 via a shaft 94. The second energy generating module in FIG. 7 comprises an internal combustion engine 130 which drives a generator 134 via a shaft 132. The third energy generating module in FIG. 7 has an internal combustion engine 138 which drives a generator 142 via a shaft 140.

Depending on operating requirements, the three energy generating modules 92, 96; 130, 134; 138, 142 can be in operation simultaneously, or it is also possible, for example, for one of these three energy generating modules to be disconnected or to be idling on standby.

Furthermore, for example, two of these energy generating modules can operate with full power to power the three electric motors 104, 110, 116 in each case according to the requirements existing there, divided up by the central control unit 146 in FIG. 7. Furthermore, for example in cruise flight, only the electric motor 116 for the tail propeller 118 can be operated with full power, whereas the electric motors 104, 110 for the front propellers 106, 112 are operated with reduced power so that these propellers do not provide any unnecessary resistance to the forward thrust.

To increase redundancy and reliability, but also to briefly increase the power (“boost”), electrical energy can be used which, in the case of the hybrid drive of FIG. 7, is supplied by the battery 120, or is supplied to the control unit 146 via a line 148 from a fuel cell unit 150.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A tilt-wing aircraft comprising:
a tail drive; and
a control unit that generates a forward thrust, and generates at least one of an upwardly, downwardly and laterally directed thrust component in hover flight and in climb flight of the aircraft.

2. The tilt-wing aircraft according to claim 1, wherein the tail drive and control unit further comprises a propeller creating an air flow against an empennage of the aircraft.

3. The tilt-wing aircraft according to claim 1, wherein the tail drive and control unit further comprises a sheathed tail propeller.

4. The tilt-wing aircraft according to claim 3, wherein the sheathed tail propeller generates an upwardly or downwardly directed thrust component and a laterally directed thrust component.

5. The tilt-wing aircraft according to claim 2, wherein a number of 2 n propellers is provided for the tilt wing, where n is a positive integer.

6. The tilt-wing aircraft according to any one of claim 5, further comprising a hybrid drive which, for each propeller, includes a respective electric motor that drives the propeller.

7. The tilt-wing aircraft according to claim 6, wherein the hybrid drive further comprises at least one energy generating module that includes an internal combustion engine and a generator to generate electrical energy for at least one of the respective electric motors.

8. The tilt-wing aircraft according to claim 7, wherein at least one further energy generating module is provided.

9. The tilt-wing aircraft according to claim 7, wherein the hybrid drive further comprises a storage unit for electrical energy.

10. The tilt-wing aircraft according to claim 7, wherein the at least one energy generating module and the further energy generating module are similar.

11. The tilt-wing aircraft according to claim 8, wherein the further energy generating module is configured as a fuel cell unit.

12. A method for operating a tilt-wing aircraft, comprising:
generating electrical energy by at least one energy generating module; and
distributing the electrical energy onto a plurality of electric motors which drive a plurality of propellers to create at least one of an upwardly, downwardly and laterally directed thrust component in hover flight and in climb flight of the aircraft, depending on operating requirements.

13. The method according to claim 12, wherein the plurality of propellers includes at least one tail propeller and the method further comprises:
in cruise flight, distributing most of the electrical energy to one of the plurality of electric motors to drives the at least one tail propeller.

14. The method according to claim 12, wherein the plurality of propellers includes at least one sheathed tail propeller, and the method further comprises:
generates an upwardly or downwardly directed thrust component and a laterally directed thrust component with the at least one sheathed tail propeller.

15. The method according to claim 12, wherein generating electrical energy by the at least one energy generating module further comprises:
generating electrical energy with an internal combustion engine and a generator.

16. The method according to claim 12, wherein generating electrical energy by the at least one energy generating module further comprises:
generating electrical energy with a fuel cell.
